(19) United States
(12) Patent Application Publication
(10) Pub. No.: US 2014/0289599 A1
(43) Pub. Date: Sep. 25, 2014

(54) ELECTRONIC BOOK

(71) Applicants: James Edward Huggins, Wiltshire (GB); Philip Michael Outlaw, London (GB)

(72) Inventors: James Edward Huggins, Wiltshire (GB); Philip Michael Outlaw, London (GB)

(21) Appl. No.: 14/113,105

(22) PCT Filed: Apr. 23, 2012
(86) PCT No.: PCT/GB2012/000375

§ 371 Date: Mar. 19, 2014

(30) Foreign Application Priority Data
Apr. 21, 2011 (GB) 1106961.4

(51) Int. Cl. G06F 17/21

(52) U.S. Cl. CPC G06F 17/211
USPC 715/209

(57) ABSTRACT

Electronic book device and method comprising: a screen for displaying an electronic book. A processor arranged to receive a signal defining a selected area within the electronic book, configure the selected area to launch a function, and execute the function when launched from the selected area.

### FIELD OF THE INVENTION

The present invention relates to an electronic book and reader and in particular to a customisable electronic book.

### BACKGROUND OF THE INVENTION

Electronic book or e-book readers include dedicated devices such as the Amazon Kindle™, Sony Portable Reader System and the Barnes and Noble Nook™ amongst others. E-book reader software may be run on other computing devices such as desktops, laptops, tablet computers and mobile handheld devices. For text-only publications, e-book readers may render the text in a format suitable for the particular operating device on a display screen for viewing by a reader.

Books containing a mixture of graphics and text present difficulties to standard e-book readers as the graphics or pictures make it difficult for presentation into a required format. This can become a particular problem for childrens' books in which the text and graphics have particular artistic importance to a reader.

Interacting with an electronic book can enhance the reader experience, especially where the reader is a young child, and not necessarily familiar with electronic devices. Interactions may include animations or playback of a pre-recorded voice reading the book text.

However, there are required further improvements to e-book readers to enhance a reader's experience.

Therefore, there is required an electronic book that overcomes these problems.

### SUMMARY OF THE INVENTION

Against this background and in accordance with a first aspect there is provided a method of customising, configuring or editing an electronic book comprising the steps of: selecting an area within the electronic book; and configuring the selected area to launch a function. Therefore, areas or portions within the electronic book may be customised so that they launch a particular function. This may be an electronic function executed by the same hardware that presents or plays the electronic book. In this way, the user experience may be enhanced and improved. The area may be selected, isolated, identified or otherwise chosen and configured to launch or execute a function or operation. Therefore, selected areas or portions maybe defined as hotspots. Selecting an area may include defining a new area or reconfiguring a previously defined or factory set area or existing hotspot. Customisation may be performed by a reader during playback of the electronic book and after loading or downloading the electronic book onto the e-book reader. Customisation takes place on the e-book reader. The e-book reader may include an input device used to supply material or media that may be launched as part of or as the function. The function may be executed when launched from the selected area.

Preferably, the selected area may be within an electronic page of the electronic book. The electronic book may be organised or arranged as a collection of electronic pages that may mimic or represent the format of a paper book. The selected areas form a portion of an electronic page.

Optionally, configuring the function may further comprise recording audio data. This may be recorded or stored using hardware integrated within an electronic book reader or external to it.

Preferably, the audio data may be a voice recording. This may be a voice recording from a reader or other user. For example, a parent may select an area to launch a recording of their own voice reading a particular portion of a story.

Optionally, selecting an area may further comprise drawing around a portion of a screen displaying the electronic book or electronic page. Drawing may be accomplished using a pointing device or preferably, by hand gesture using a touch screen.

Optionally, selecting an area may further comprise selecting one of a plurality of predefined areas. Predefined areas may be set when preparing the electronic book by an author or publisher. These areas may substantially encompass existing items within the electronic book such as text, paragraphs, characters, drawings or other features, for example.

Preferably, the area may be user defined. Therefore, any portion of the electronic book may be selected and configured by a user. This may include portions of or entire predefined areas or hotspots already configured to perform functions.

Optionally, the user defined area may be defined by freely drawing on a screen displaying the electronic book.

Optionally, the method may further comprise the step of entering an edit mode before selecting the area. The electronic book may be toggled between play mode and edit or customisation mode.

Optionally, the method may further comprise the step of highlighting one or more areas configured to launch functions after entering the edit mode. In edit mode existing launch areas or hotspots may be visible or highlighted by a change of colour, contrast or with a border, for example. In play mode the hotspots may be hidden, partially hidden (e.g. greyed out or having a slightly different colour or shade) or only visible (or additionally highlighted) when tapped or used to launch a function.

Optionally, the method may further comprise the step of exiting the edit or configuration mode to hide or partially hide the one or more areas configured to launch the functions.

Optionally, the method may further comprise the step of launching the function by tapping the area displayed on a touch screen.

Preferably, the electronic book may be a picture book. The electronic book may include both text and drawings.

Optionally, the electronic book may comprise preconfigured areas arranged to launch functions and user configured areas arranged to launch functions. Therefore, the electronic book may be factory or publisher set to have existing hotspots that may be supplemented with user defined or configured hotspots.

Optionally, the electronic book may configurable to invoke the preconfigured areas, the user configured areas or both during playback. Buttons or touch areas may be used to configure the electronic book in this way.

According to a second aspect, there is provided an electronic book device, reader, portable, desktop or tablet computer comprising: a screen for displaying an electronic book; and a processor arranged to receive a signal defining a selected area within the electronic book, configure the selected area to launch a function, and execute the function when launched from the selected area. The electronic book device or reader may be a dedicated device, a portable electronic device, a laptop, desktop computer, tablet computer, mobile telephone or similar device with a suitable processor.

Preferably, the screen may be a touch screen. This may simplify customisation or configuration as the selected areas may be directly defined within the electronic book using the touch screen.

The method may be implemented as a computer program comprising program instructions that, when executed on a computer cause the computer to perform the method or methods described above. The computer program may be stored on a computer-readable medium.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of an electronic book reader;

FIG. 2 shows a schematic diagram of the electronic book reader of FIG. 1, indicating a touch sensitive screen and audio output;

FIG. 3 shows a schematic diagram of the electronic book reader of FIG. 1, indicating hotspot areas on the touch sensitive screen;

FIG. 4 shows a schematic diagram of the electronic book reader, indicating user interaction with the hotspots;

FIG. 5 shows a schematic diagram of the electronic book reader of FIG. 1, indicating customisation of the hotspots;

FIG. 6 shows a schematic diagram of the electronic book reader showing further customisation;

FIG. 7 shows the electronic book reader and display after customisation;

FIG. 8 shows the electronic book reader in a play mode; and

FIG. 9 shows a schematic diagram of the components forming the electronic book reader.

It should be noted that the figures are illustrated for simplicity and are not necessarily drawn to scale.

### DETAILED DESCRIPTION OF THE PREFERRED EMBODIMENTS

An electronic book or e-book reader may be a dedicated device or suitable software executed on a desktop or portable computer. Tablet computers may be particularly suitable for use as electronic book readers. For example, a suitable device may be an iPad provided by Apple Inc. executing the ICS operating system. A plurality of electronic books may be added to the electronic book reader using an internal or external network such as the Internet or loading them from a computer readable medium such as a flash memory card, for example.

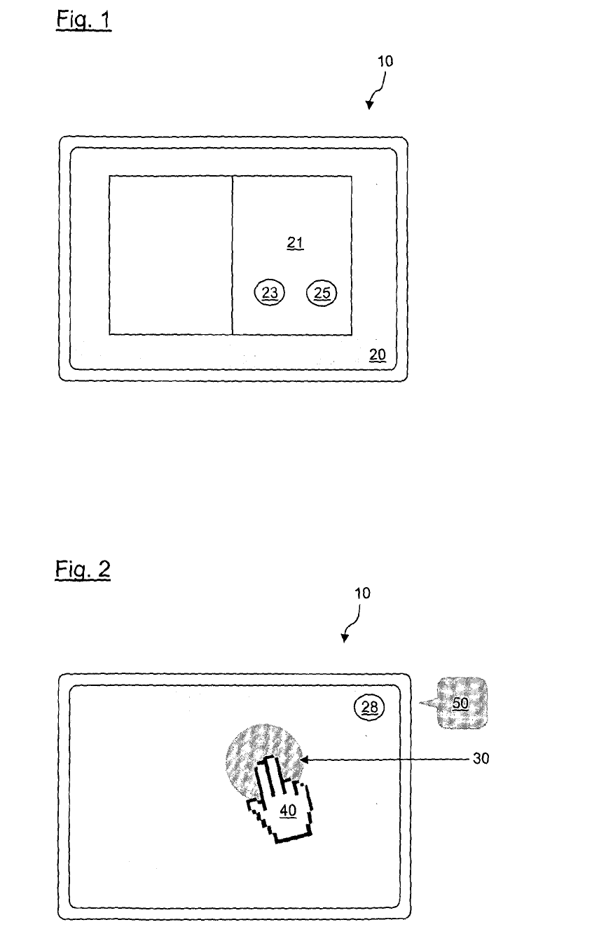

FIG. 1 shows a schematic diagram of a tablet computer or other type of e-book reader 10 having a touch screen 20 used to interact with the e-book reader 10. Tablet computer is loaded with suitable e-book reading software.

After initiating the e-book reader software, a particular e-book 21 may be selected by the user for viewing. This e-book is then displayed on the touch screen 20 and in the present example shown in FIG. 1, the first two pages of the e-book 21 are displayed. The reader controls interaction with the e-book 21 using the touch screen 20 by for instance, turning the pages and selecting various controller options. FIG. 1 shows two touch buttons 23 and 25 for controlling how the e-book is presented. These functions will be discussed in further detail in the following description. The e-book 21 may be displayed on a portion of the touch screen 20 as shown in FIG. 1, or in full screen mode.

The e-book may have embedded hotspots or selectable areas or portions that are configured to launch particular functions such as playing pre-recorded audio, for example. These hotspots may be hidden or easily identifiable to the user who may tap on them to launch or execute the associated or linked function.

FIG. 2 shows the e-book in full screen mode having a hotspot 30 being tapped by the user 40, which launches a function 50 playing back pre-recorded audio. The e-book may be configurable or customisable within some or all of the pages by tapping a configuration button 28, which places the e-book into an edit or configuration mode.

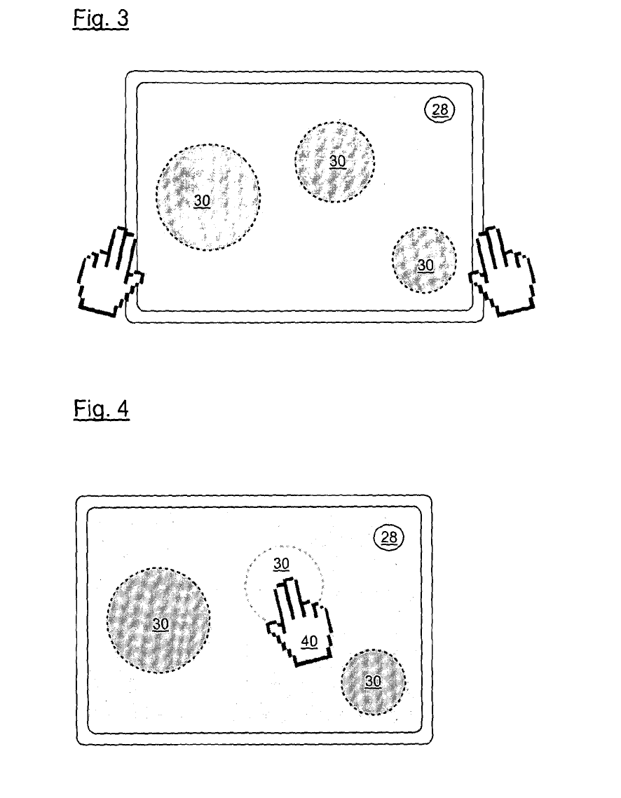

FIG. 3 shows the e-book in edit mode following a tap on configuration button 28, which reveals or highlights the locations of any hotspots 30 on the particular page being displayed of the electronic book 21.

FIG. 4 shows the e-book in edit mode in which the user 40 may edit or configure the particular function launched by each hotspot by tapping any revealed hotspot 30. Double tapping a hotspot 30 may be used to delete it. During edit mode, the user 40 may test or launch the particular function associated with each hotspot or amend or change the particular function associated with the hotspots 30.

FIG. 5 illustrates a further operation that may be carried out by the user 40 in edit mode in which new hotspots 130 are defined by the user 40. New hotspots 130 may be provided by selecting a particular area within the electronic book 21. Selecting the area may be achieved by drawing around a particular area within the electronic book or a page of the electronic book using the touch screen 20.

Therefore, the area may be selected by enclosing it by drawing around it. Once the area is selected and defined by the user 40, it may be configured. Other selection options may be used.

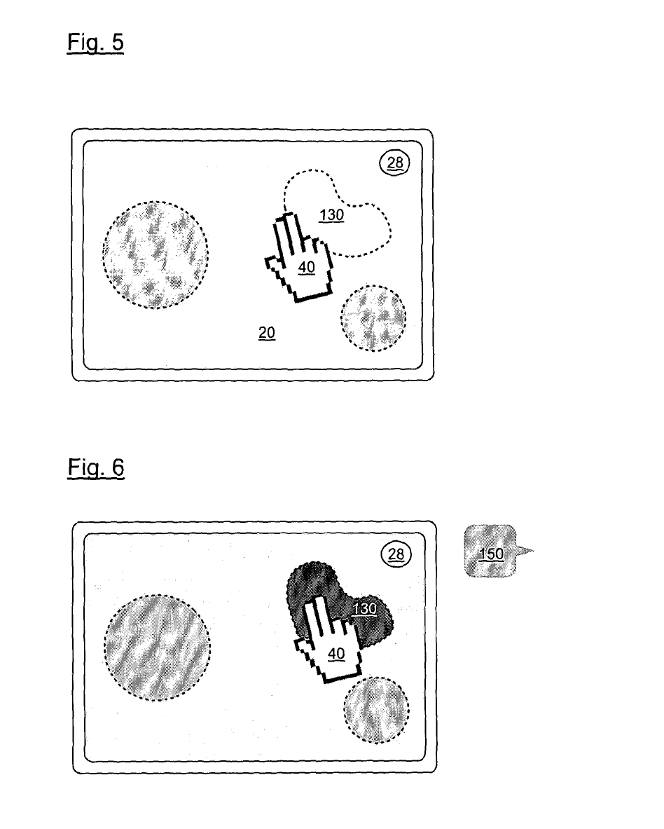

FIG. 6 shows the configuration of the user defined hotspot 130. In this example, this configuration is achieved by the user 40 tapping and holding the new hotspot 130. The particular hotspot 130 configured in this way may be indicated on the touch screen by changing its appearance. For example, the hotspot 130 being configured may change colour or flash, indicating that it is being configured to launch or execute a particular function. In the example shown in FIG. 6, the function being configured is the launching of pre-recorded audio 150 that came with the e-book 21. In other words, tapping the new hotspot 130 initiates an audio recorder whereby speech or other audio 150 is recorded by the e-book reader 10 using an integrated or external microphone (not shown in the figure). Other functions may be configured to be launched by user configurable hotspots 130. These may include the launch of a particular image on the touch screen 20 or video that may be captured by the e-book reader 10 using an integrated or external camera (not shown in the figure).

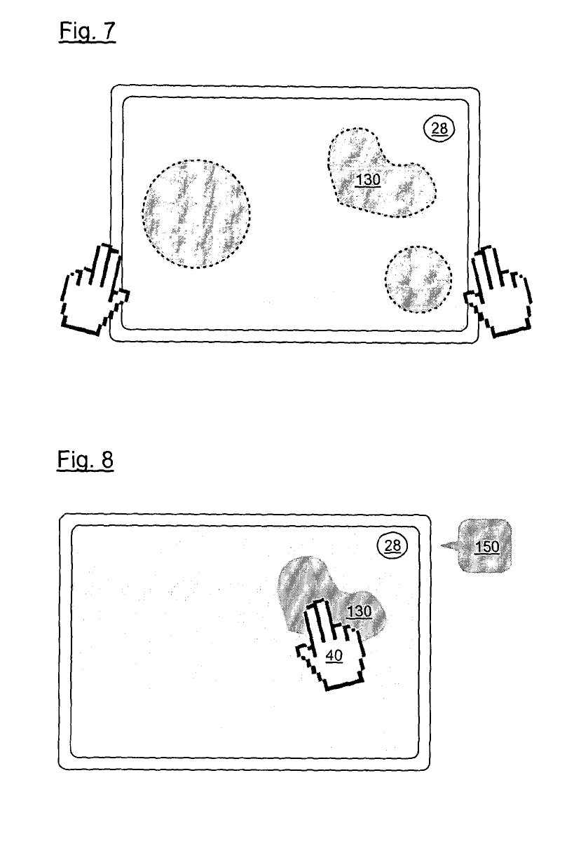

The recording of audio 150 or other functions associated with the new hotspot 130 may be completed by tapping the user configurable hotspot 130. FIG. 7 shows the e-book reader 10 following configuration of a selected area of the electronic book to launch a particular function but with the e-book reader remaining in edit mode. Play mode may be resumed by exiting edit mode by tapping configuration button 28. The reader may toggle between edit and play mode at any point or page within the e-book.

FIG. 8 shows a schematic diagram of the e-book reader once play mode has been resumed with the predefined hotspots 30 and user defined hotspot 130 hidden or un-highlighted.

On tapping the user defined hotspot 130 by the user 40, the recorded audio 150 is played back.

With user defined hotspots 130 placed throughout the e-book 21, various further options may be available for playback. These may include making available only pre-recorded factory set hotspots 30, only user customised hotspots 130 or a combination of both. These different options may be made using the touch buttons 23 and 25 shown on the first pages of the e-book 21, as illustrated in FIG. 1.

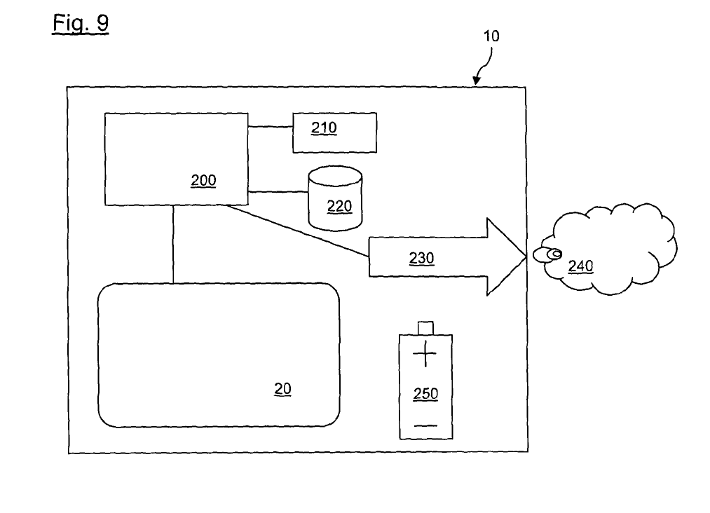

FIG. 9 shows a schematic diagram of a device suitable for displaying and configuring the electronic book 21. As described above, the device 10 may be a dedicated e-book reader or a general purpose computer or tablet computer, for example. In this particular example, the e-book reader 10 is a tablet computer. The tablet computer 10 may have a processor such as a 1 GHz dual-core Apple AS system on a chip. The touch screen 20 may be a 25 cm multi-touch display with a resolution of 1024×768 pixels with LED backlighting. A memory 210 book reader may be included that may be for example a 512 MB DDR2 RAM. Storage 210 may be 64 GB flash RAM. Various types of interface 230 may be included in order to allow the e-book reader 10 to communicate with external networks 240 such as the Internet. Interfaces may be wireless or wired (e.g. Wi-fi, 3G or USB).

Storage 220 may be used to store one or more e-books along with associated with customisation parameters. The device may be powered by a battery 250 or other suitable power sources.

The e-book reader software may be an application developed in a suitable computer language (for instance C, C++, AppleScript, Python or Ruby) that may be built using a software developer kit such as iOS SDK.

As will be appreciated by the skilled person, details of the above embodiment may be varied without departing from the scope of the present invention, as defined by the appended claims.

For example, user configured hotspots may be shared or transmitted with other e-books along with their launchable functions or audio recordings.

The method and apparatus may also be a way of customising a set of electronic data comprising text and/or figures. Electronic books may take many forms and not necessary limited to electronic versions of paper books although at present they usually are.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method of customising an electronic book comprising the steps of:
selecting an area within the electronic book; and
configuring the selected area to launch a function.

2. The method of claim 1, wherein the selected area is within an electronic page of the electronic book.

3. The method of claim 1 or claim 2, wherein configuring the function further comprises recording audio data.

4. The method of claim 3, wherein the audio data is a voice recording.

5. The method according to any previous claim, wherein selecting an area further comprises drawing around a portion of a screen displaying the electronic book.

6. The method according to any of claims 1 to 4, wherein selecting an area further comprises selecting one of a plurality of predefined areas.

7. The method according to any previous claim, wherein the area is user defined.

8. The method of claim 7, wherein the user defined area is defined by freely drawing on a screen displaying the electronic book.

9. The method according to any previous claim further comprising the step of entering an edit mode before selecting the area.

10. The method according to claim 9 further comprising the step of highlighting one or more areas configured to launch functions after entering the edit mode.

11. The method of claim 9 or claim 10 further comprising the step of exiting the edit mode to hide the one or more areas configured to launch the functions.

12. The method according to any previous claim further comprising the step of launching the function by tapping the area displayed on a touch screen.

13. The method according to any previous claim, wherein the electronic book is a picture book.

14. The method according to any previous claim, wherein the electronic book comprises preconfigured areas arranged to launch functions and user configured areas arranged to launch functions.

15. The method of claim 14, wherein the electronic book is configurable to invoke the preconfigured areas, the user configured areas or both during playback.

16. An electronic book device comprising:
a screen for displaying an electronic book; and
a processor arranged to receive a signal defining a selected area within the electronic book, configure the selected area to launch a function, and
execute the function when launched from the selected area.

17. The electronic book of claim 16, wherein the screen is a touch screen.

18. A computer program comprising program instructions that, when executed on a computer cause the computer to perform the method of any of claims 1 to 15.

19. A computer-readable medium carrying a computer program according to claim 20.

20. A computer programmed to perform the method of any of claim 1 to 15 or 18.
